(19) United States
(12) Patent Application Publication
(10) Pub. No.: US 2016/0226324 A1
(43) Pub. Date: Aug. 4, 2016

(54) TIME DIFFERENCE-BASED GENERATOR USING BALANCE OF BOTH POLES

(71) Applicant: Jong-Suk AN, Daejeon (KR)

(72) Inventor: Jong-Suk AN, Daejeon (KR)

(21) Appl. No.: 14/916,006

(22) PCT Filed: Sep. 3, 2014
(86) PCT No.: PCT/KR2014/008262

§ 371 Date: Mar. 2, 2016

(30) Foreign Application Priority Data
Sep. 5, 2013 (KR) 10-2013-0106493

(51) Int. Cl. H02K 1/18; H02K 1/14; H02K 1/27; H02K 1/02

(52) U.S. Cl. CPC H02K 1/182; H02K 1/02; H02K 1/14; H02K 1/2793

(57) ABSTRACT

The present invention relates to a time difference-based generator using the balance of both poles and specifically comprises: a pair of fixing plates, each having a rotating-shaft through-hole formed in the center thereof and a plurality of ferrite core fixing holes formed along a circle with a predetermined diameter; a plurality of ferrite cores fixedly provided between the pair of fixing plates in such a manner that the ends of the ferrite cores are inserted into the ferrite core fixing holes, the ferrite cores allowing the magnetic field to make a closed circuit; a plurality of winding coils provided in such a manner to be wound around the outer circumference of the ferrite cores by a predetermined number of rotation; a pair of rotating plates for rotors, arranged adjacent to the outer surface of the pair of fixing plates and fixed to the ends of a rotating-shaft provided in such a manner to pass through the rotating-shaft through-holes formed in the center of the fixing plates; and a plurality of permanent magnets fixedly provided at predetermined intervals and positions in such a manner that the S poles and the N poles inside the rotating plates for rotors face each other so as to be opposite to each other. Thus, the generator can greatly improve the generation efficiency thereof and greatly increase the generation capacity, and thus greatly improve the marketability and reliability thereof.

### TECHNICAL FIELD

The invention relates to a time difference-based generator using a balance of both poles, more particularly, to a time difference-based generator using a balance of both poles in that a plurality of ferrite cores is fixedly formed at predetermined intervals and positions between a pair of fixing plates, which is arranged in parallel with each other at regular distances intervals; a pair of rotor rotating plates, in which one or more permanent magnets are fixedly formed at predetermined intervals and positions, is formed at the outside of the pair of fixing plates; and a rotating-shaft fixedly formed on a center point of the rotor rotating plate is connected to a shaft of a rotation force generating means, so that voltages (that is, independent generator) are independently generated with different time differences in each winding coil wound on the plurality of ferrite cores.

### BACKGROUND ART

In general, a generator is a device of changing a mechanical energy, which is generated from various energy sources such as a chemical energy or a nuclear energy, into an electrical energy in accordance with Fleming's right-hand rule, which is a rule for determining the direction of an induced electromotive force or an induced current toward the direction of a magnetic field and the moving direction of a conductive wire when the conductive wire is moved in the magnetic field, by using an electricity generated when the conductor is moved in the magnetic field. It is distinguished by an AC generator and a DC generator.

Recently, a generator according a linear motion has been developed. However, most of the generators include a rotating type. However, all the generators are identical with each other in a point which an electromotive force generated by an electromagnetic induction action.

Typically, the generator includes a field magnet portion of forming the magnetic field and an armature portion of performing a rotational motion in the magnetic field.

At this time, the field magnet portion of forming the magnetic field by means of the magnet line of force refers to a magnet bonded to a housing of the generator.

In addition, the armature portion means a portion of emitting the magnet line of force by applying a current thereto and refers to an armature, a rotor or a core.

In the generator having the above configuration, the magnetic field is always formed around an electric wire, in which the electric current flows, and the armature is rotated by a force of mutually pushing or pulling the magnetic field of the permanent magnet and the magnetic field generated in the coil of the armature. At this time, it uses such an electromagnetic force.

On the other hand, in the process of generating the electricity between the magnetic field and the coil in the conventional generator, a hysteresis loss owing to a counter-electromotive current and an eddy current owing to a magnetic motion are generated, so that a wasteful and strong load and a heat are generated.

In particular, if the over current is used and the unexpected short-circuit current condition occurs, there is a problem in that various instruments and equipments can be damaged by means of the power outages due to a fire loss or a overload of the generator.

In addition, it can totally use the amount of 100 percent of the actual power produced. However, in consideration of the risk of the damage thereof, it is absolutely impossible to use closely to the entire amount of the output thereof in the face of danger of the overload.

Thus, it always uses smaller amount than the output thereof and the loss thereof is actually huge, which is the reality of the current development operations.

In addition, the force of hindering the rotor of the generator is generated owing to the magnetic field generated in the armature coil when the electric current flow in the armature coil. That is, the magnetic field interacts with the magnetic field of the rotor, so that it causes a counter electromotive force that hinders the rotation of the rotor.

### CITATION LIST

### Patent Literature

[Patent Literature 1]

Korean Utility Model Registration No. 20-0386338 (May 31, 2005)

[Patent Literature 2]

Korean Patent publication No. 10-2005-0112619 (Dec. 1, 2005)

[Patent Literature 3]

Korean Patent publication No. 1997-0077907 (Dec. 12, 1997)

### DISCLOSURE

### Technical Problem

The present invention has been made in an effort to solve the problems of the conceptual description of the conventional art as described above, and an object of the present invention is to provide a time difference-based generator using a balance of both poles in that a plurality of linear ferrite cores of a rod shape is fixedly formed at predetermined intervals and positions between a pair of fixing plates which is arranged in parallel with each other at regular distances intervals; a pair of rotor rotating plates having a circular shape, an “I” shape, or an “Y” shape, in which one or more permanent magnets are fixedly formed at predetermined intervals and positions in such a manner that opposite poles (that is, S poles and N poles) face each other, is formed at the outside of the pair of fixing plates; and a rotating-shaft fixedly formed on a center point of the rotor rotating plate is connected to a shaft of a rotation force generating means, so that the balance of both poles is established and it acts as an independent generator capable of independently generating the induced electromotive forces or the induced currents with the different time differences in the winding coils wound on each ferrite core, thereby minimizing the heat generated from the ferrite core and the winding coils so as to greatly improve a generation efficiency thereof and greatly increase a generation capacity thereof.

### Technical Solution

According to one aspect of the present invention so as to accomplish these objects, there is provided to a time difference-based generator using a balance of both poles including: a pair of fixing plates integrally coupled to each other through a fixing and space maintaining means so as to maintain a parallel state in a vertical direction, each having a rotating-shaft through-hole formed in the center thereof and a plurality of ferrite core fixing holes formed at regular intervals along a circle with a predetermined diameter; a plurality of ferrite cores of a rod shape fixedly provided between the pair of fixing plates in such a manner that both ends of the ferrite cores are inserted into the ferrite core fixing holes, the ferrite cores allowing a magnetic field generated from permanent magnets when each permanent magnet passes by both ends of the ferrite cores exposed to outside of the fixing plates to make a closed circuit; a plurality of winding coils provided in such a manner to be wound around an outer circumference of the ferrite cores by a predetermined number of rotation and inducing an induced electromotive force or an induced current generated when the magnetic field of the permanent magnets passes through each ferrite core so as to transmit the induced electromotive force or the induced current to a power control unit; a pair of rotor rotating plates arranged adjacent to an outer surface of the pair of fixing plates and fixed to both ends of a rotating-shaft 51 provided in such a manner to pass through the rotating-shaft through-holes formed in the center of the fixing plates so as to rotate with the rotating-shaft in response to the number of rotation of the rotating-shaft connected to a shaft of a rotation force generating means; and the plurality of the permanent magnets fixedly provided at predetermined intervals and positions in such a manner that S poles and N poles inside the rotor rotating plates face each other so as to be opposite to each other for providing the magnetic field to the plurality of ferrite cores.

At this time, the ferrite cores and the permanent magnet generators are formed with an odd or an even number or an even or an odd number in opposition to each other

Also, the pair of fixing plates further includes a plurality of ferrite core fixing holes formed at regular intervals along a plurality of circles with different diameters in multiple stages and ferrite cores having the winding coils wound around the outer circumference thereof are further formed at each pair of the ferrite core fixing holes in a position facing each other.

At this time, in the pair of the fixing plates, the plurality of ferrite core fixing holes formed at regular intervals along the plurality of circles with different diameters in multiple stages and the ferrite cores fixed thereto are radially formed and installed at a predetermined angle from a center point of the fixing plate.

Also, the rotor rotating plate is any one of a circular shape, an “I” shape, an “Y” shape, and a “+” shape.

In addition, a plurality of permanent magnets, which is formed at regular intervals along a plurality of circles with different diameters, is further formed at an inside of the rotor rotating plate in multiple stages in response to the installation locations of each ferrite core fixed to the ferrite core fixing holes, which are formed at regular intervals along the plurality of circles with different diameters in multiple stages.

At this time, the permanent magnets are rotated in accordance with the rotation of the rotor rotating plate and the permanent magnets are arranged in the form of an “I” shape, an “Y” shape, or a “+” shape as it is viewed from a center point of the rotor rotating plate so as to allow the permanent magnets to be close to one or more pairs of the ferrite cores at a time when they are close to both ends of the ferrite cores.

Also, a terminal plate having a plurality of terminals is further formed at one fixing plate or both fixing plates so as to fix both ends of the winding coils wound on each ferrite core and input terminals of the power control unit connected to each winding coils thereto.

In the meantime, the fixing and space maintaining means includes: a plurality of supporters formed in the form of a circular rod having predetermined diameter and length and installed between the pair of fixing plates; and a plurality of bolts and nuts for mutually fixing the pair of fixing plates to the supporter in a state that the supporters passes through the pair of fixing plates, respectively.

### Advantageous Effects

According to the time difference-based generator using the balance of both poles of the present invention as described above, the plurality of linear ferrite cores of a rod shape is fixedly formed at predetermined intervals and positions between the pair of fixing plates, which is arranged in parallel with each other at regular distances intervals; the pair of rotor rotating plates having the circular shape, the “I” shape, or the “Y” shape, in which one or more permanent magnets is fixedly formed at predetermined intervals and positions in such a manner that the opposite poles (that is, S poles and N poles) face each other, are formed at the outside of the pair of fixing plates; and the rotating-shaft fixedly formed on the center point of the rotor rotating plate is connected to the shaft of the rotation force generating means, so that the balance of both poles is established and it acts as the independent generator capable of independently generating the induced electromotive forces or the induced currents with the different time differences in the winding coils wound on each ferrite core of a “−” shape, thereby minimizing the heat generated from the ferrite core and the winding coils so as to greatly improve a generation efficiency thereof and greatly increase a generation capacity thereof. Accordingly, it can greatly improve the marketability and reliability thereof.

### BRIEF DESCRIPTION OF DRAWINGS

The above and other objects, features and advantages of the present invention will be more apparent from the following detailed description taken in conjunction with the accompanying drawings, in which:

FIG. 1 is a perspective view illustrating a generator according to an embodiment of the present invention;

FIG. 2 is a sectional view illustrating a generator according to an embodiment of the present invention;

FIG. 3 (a)-(d) are front views illustrating various examples of rotor rotating plates according to an embodiment of the present invention;

FIG. 4 is a front view illustrating a fixing plate of a generator according to another embodiment of the present invention; and

FIGS. 5 (a) and (b) are front views illustrating examples of rotor rotating plates according to another embodiment of the present invention.

### REFERENCE SIGNS LIST

1: fixing plate
11: rotating-shaft through-hole
12: ferrite core fixing hole
2: fixing and space maintaining means
22: bolt
23: nut
3: ferrite core
4: winding coil
5: rotor rotating plate
51: rotating-shaft
6: permanent magnet
7: terminal plate
8: power control unit
9: rotation force generating means

### BEST MODE

### Mode for Invention

Hereinafter, a preferred embodiment according to the present invention will be described in detail with reference to the accompanying drawings.

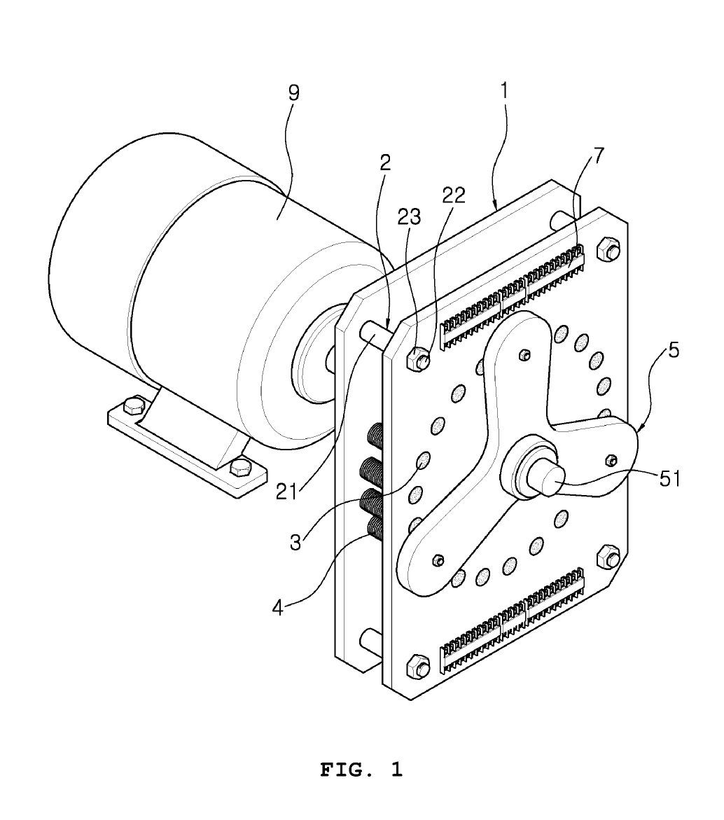

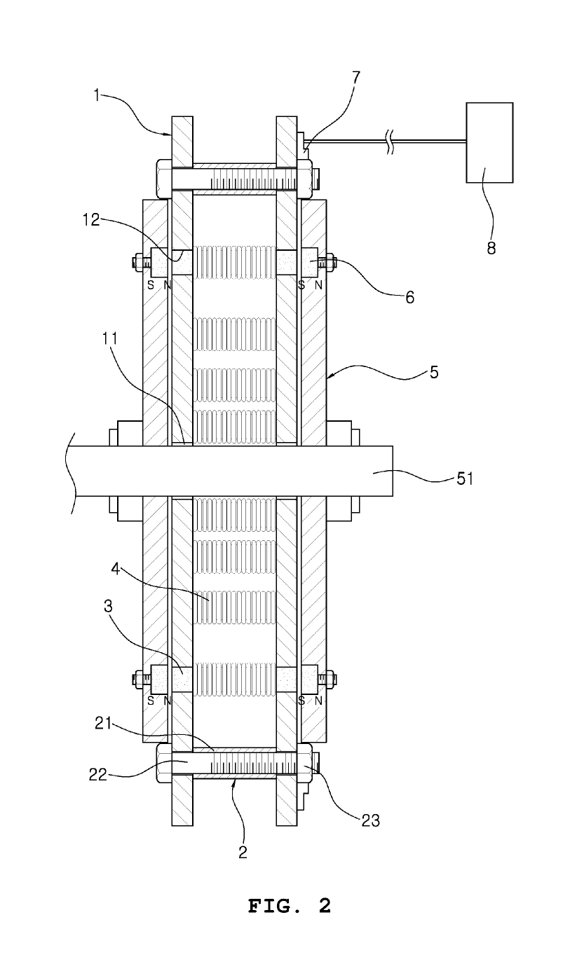

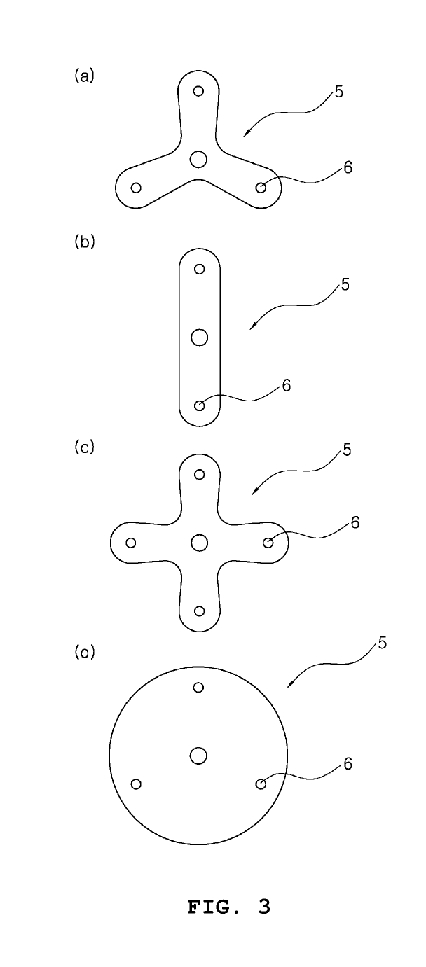

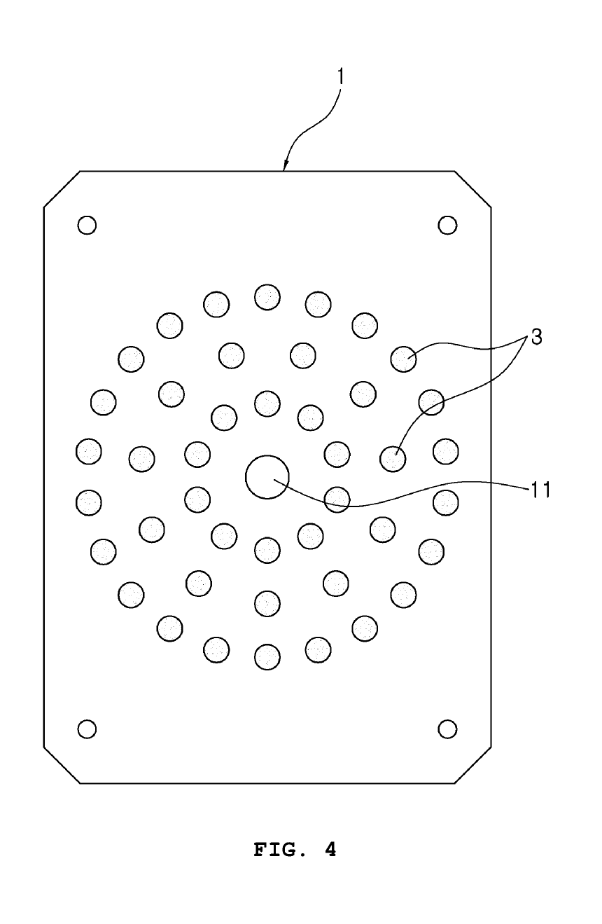

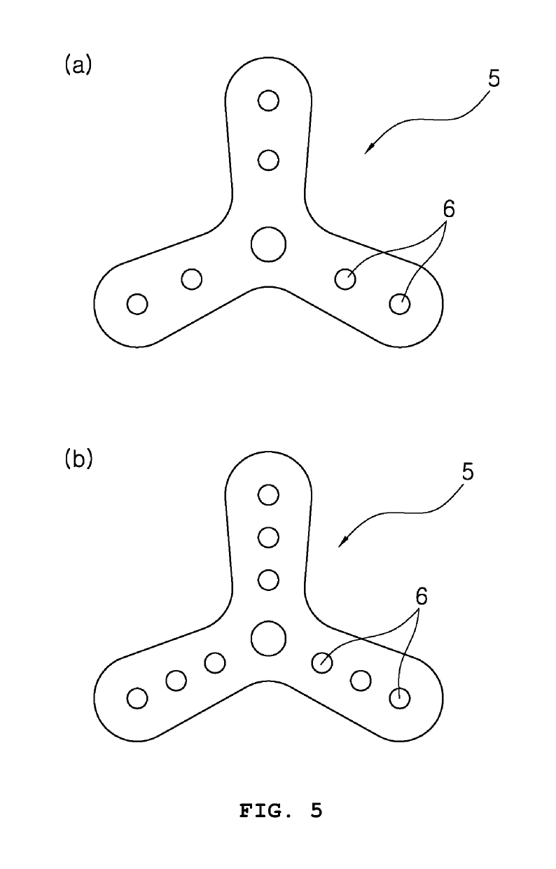

FIG. 1 is a perspective view illustrating a generator according to an embodiment of the present invention, FIG. 2 is a sectional view illustrating a generator according to an embodiment of the present invention, FIG. 3 (a)-(d) are front views illustrating various examples of rotor rotating plates according to an embodiment of the present invention, FIG. 4 is a front view illustrating a fixing plate of a generator according to another embodiment of the present invention, and FIGS. 5 (a) and (b) are front views illustrating examples of rotor rotating plates according to another embodiment of the present invention.

A time difference-based generator using a balance of both poles according to the present invention includes:

a pair of fixing plates 1 integrally coupled to each other through a fixing and space maintaining means 2 so as to maintain a parallel state in a vertical direction, each having a rotating-shaft through-hole 11 formed in the center thereof and a plurality of ferrite core fixing holes 12 formed at regular intervals along a circle with a predetermined diameter;

a plurality of ferrite cores 3 of a rod shape fixedly provided between the pair of fixing plates 1 in such a manner that both ends of the ferrite cores are inserted into the ferrite core fixing holes 12, the ferrite cores 3 allowing a magnetic field generated from permanent magnets 6 when each permanent magnet 6 passes by both ends of the ferrite cores exposed to outside of the fixing plates 1 to make a closed circuit;

a plurality of winding coils 4 provided in such a manner to be wound around an outer circumference of the ferrite cores 3 by a predetermined number of rotation and inducing an induced electromotive force or an induced current generated when the magnetic field of the permanent magnets 6 passes through each ferrite core 3 so as to transmit the induced electromotive force or the induced current to a power control unit 8;

a pair of rotor rotating plates 5 arranged adjacent to an outer surface of the pair of fixing plates 1 and fixed to both ends of a rotating-shaft 51 provided in such a manner to pass through the rotating-shaft through-holes 11 formed in the center of the fixing plates 1 so as to rotate with the rotating-shaft 51 in response to the number of rotation of the rotating-shaft 51 connected to a shaft of a rotation force generating means 9; and

the plurality of the permanent magnets 6 fixedly provided at predetermined intervals and positions in such a manner that S poles and N poles inside the rotor rotating plates 5 face each other so as to be opposite to each other for providing the magnetic field to the plurality of ferrite cores 3.

In this case, the ferrite cores 3 and the permanent magnet generators are formed with an odd or an even number or an even or an odd number in opposition to each other.

In addition, the pair of the fixing plates 1 further includes a plurality of ferrite core fixing holes 12 formed at regular intervals along a plurality of circles with different diameters in multiple stages and ferrite cores 3 having the winding coils 4 wound around the outer circumference thereof are further formed at each pair of the ferrite core fixing holes 12 in a position facing each other.

At this time, in the pair of the fixing plates 1, the plurality of ferrite core fixing holes 12 formed at regular intervals along the plurality of circles with different diameters in multiple stages and the ferrite cores 3 fixed thereto are radially formed and installed at a predetermined angle from a center point of the fixing plate.

Further, the rotor rotating plate 5 is any one of a circular shape, an “I” shape, an “Y” shape, and a “+” shape.

In addition, a plurality of permanent magnets, which is formed at regular intervals along a plurality of circles with different diameters, is further formed at an inside of the rotor rotating plate 5 in multiple stages in response to the installation locations of each ferrite core 3 fixed to the ferrite core fixing holes 12, which are formed at regular intervals along the plurality of circles with different diameters in multiple stages.

In this case, the permanent magnets 6 are rotated in accordance with the rotation of the rotor rotating plate 5 and the permanent magnets 6 are arranged in the form of an “I” shape, an “Y” shape, or a “+” shape as it is viewed from the center point of the rotor rotating plate 5 so as to allow the permanent magnets 6 to be close to one or more pairs of ferrite cores 3 at a time when they are close to both ends of the ferrite cores 3.

In addition, a terminal plate 7 having a plurality of terminals is further formed at one fixing plate 1 or both fixing plates 1 so as to fix both ends of the winding coils 4 wound on each ferrite core 3 and input terminals of the power control unit 8 connected to each winding coils 4 thereto.

On the other hand, the fixing and space maintaining means 2 includes:

a plurality of supporters 21 formed in the form of a circular rod having predetermined diameter and length and installed between the pair of fixing plates 1; and

a plurality of bolts 22 and nuts 23 for mutually fixing the pair of fixing plates 1 to the supporter 21 in a state that the supporters 21 passes through the pair of fixing plates 1, respectively.

Hereinafter, the operation and the effect on the time difference-based generator using the balance of both poles having the above elements according to the present invention will be described.

Firstly, as shown in FIG. 1 through FIG. 3, the time difference-based generator using the balance of both poles according to the present invention basically includes the pair of fixing plates 1, the plurality of ferrite cores 3, the plurality of winding coils 4, the pair of rotor rotating plates 5, and the plurality of permanent magnets 6.

The pair of fixing plates 1, which is one of the above elements, has been molded to have a disk-like shape or a rectangular plate-like shape having predetermined thickness and volume by using a synthetic resin material having an insulating property. Basically, it includes the rotating-shaft through-hole 11 formed in the center point thereof and the plurality of ferrite core fixing holes 12 formed at regular intervals along the circle with the predetermined diameter.

In a state that such a pair of fixing plates 1 is arranged at regular intervals so as to maintain the parallel state in a vertical direction, they are integrally coupled to each other through the fixing and space maintaining means 2 including the plurality of supporters 21 and the plurality of bolts 22 and nuts 23 as shown in FIG. 2, so that it performs the fixing function of the ferrite core 3 etc. and the supporting function of the rotating-shaft for smoothly rotating the rotor rotating plate 5 etc.

At this time, in a state that the plurality of supporters 21, which is the element of the fixing and space maintaining means 2, is molded in the form of the circular rod having predetermined diameter and length, they are formed between the pair of fixing plates 1. The plurality of bolts 22 passes through the bolt through-holes formed at each corner of the fixing plates 1 and the supporter 21, respectively and the nuts are fixed to ends of the bolts 22, which are exposed to the outside of the fixing plates 1, so that the pair of fixing plates 1 is integrally fixed to each other at regular distance.

The plurality of ferrite cores 3 is molded in the form of the rod shape having the predetermined diameter and length by using the ferrite. Also, it has the outer surface thereof wound by the winding coil 4 and both ends thereof inserted into the ferrite core fixing holes 12, so that they are fixedly formed and arranged in a circle between the pair of fixing plates 1.

Such a plurality of ferrite cores 3 serves to make the closed circuit and induce the induced electromotive force or the induced current through the winding coils 4, when each permanent magnet 6 passes by both ends of the ferrite cores 3 exposed to outside of the fixing plates 1 by means of the rotation of the permanent magnets 6 together with the rotor rotating plates 5 described later.

The plurality of winding coils 4 is formed in such a manner to be wound around the outer circumference of the ferrite cores 3 by a predetermined number of rotation and induces the induced electromotive force or the induced current having a predetermined time difference (that is, time difference of passing by both ends of the ferrite cores 3 by means of the permanent magnets) and a predetermined frequency (e.g. 60 Hz) in independent and uniform shapes respectively. The induced electromotive force or the induced current independently induced in each winding coil 4 are transmitted to the power control unit 8 for performing the overall control for the generator of the present invention through a rectifying circuit (not shown) etc. so as to provide the voltage required for driving various electrical and electronic equipments.

The pair of rotor rotating plates 5 are molded to have any one shape of a circular shape, an “I” shape, an “Y” shape, and a “+” shape by using a synthetic resin material having an insulating property, as shown in FIG. 3 (a)-(d). The pair of rotor rotating plates 5 are arranged adjacent to an outer surface of the pair of fixing plates 1 and fixed to both ends of the rotating-shaft 51 provided in such a manner to pass through the rotating-shaft through-holes 11 formed in the center of the fixing plates 1.

Such a pair of rotor rotating plates 5 are rotated with the rotating-shaft 51 in response to the number of rotation of the rotating-shaft 51 connected to the shaft of the rotation force generating means 9 such as a body of rotation including an electric motor rotated by a turbine, a wind power or a water power etc. Accordingly, the permanent magnets 6 are rotated at a predetermined speed along the outer surface of the fixing plate 1, so that it can provide the magnetic field to the plurality of ferrite cores 3 with the predetermined time difference described above.

At this time, in case of the load of the pair of rotor rotating plates 5, it receives only a fine counter electromotive force when the permanent magnets passes by both ends of the ferrite core 3 of one point in accordance with the quantity consisting of one or more permanent magnets.

Also, the plurality of the permanent magnets 6 is fixedly provided at predetermined intervals and positions in such a manner that S poles and N poles inside the rotor rotating plates 5 face each other so as to be opposite to each other.

Such a permanent magnet 6 are rotated together with the rotating-shaft 51 when the rotor rotating plates 5 are rotated at a predetermined rotation speed by the rotation force generating means 9 and the magnetic field is provided to the plurality of ferrite cores 3 having both ends exposed to the outer surface of the fixing plate 1 with the predetermined time difference, so that the induced electromotive force or the induced current having a predetermined frequency are generated in each winding coil 4 wound on the ferrite cores 3.

At this time, the sizes of the fixation plate 1 and the rotor rotating plate 5 are variable and determined by the installation number of the ferrite cores 3 and the winding coil 4, the diameter, the length, and the installation number of the ferrite core 3, the length, the winding number, the diameter of the winding coil 4, and the strength and the number of the magnetic field generated by the permanent magnet 6 etc. are is determined in consideration of the generation capacity (capacity of the generator) intended to produce the electric power by means of the generator of the present invention.

In addition, the occurrence of the eddy current due to the counter electromotive force, which acts as a factor of decreasing the efficiency of the oscillator by converting the generating voltage, the current, and the frequency etc. outputted from each winding coil 4 of the generator according to the present invention into the heat during the electricity generation is determined by the number of rotation of the rotor rotating plate 5 and the permanent magnets 6 in that the number of rotation thereof is determined by the rotation force generating means 9.

On the other hand, where both the ferrite core 3 and the permanent magnet 6 are installed with an even number, since the number of the permanent magnets 6 rotated together with the rotor rotating plate 5 is coincided with that of the ferrite cores 3, it generates a force (i.e. counter-electromotive force) of interfering with the rotation of the rotor rotating plate 5 owing to the magnetic force generated from the permanent magnets.

Therefore, in the present invention, when it installs the ferrite cores 3 and the permanent magnets 6, the ferrite cores 3 and the permanent magnet generators are formed with an odd or an even number or an even or an odd number in opposition to each other, so that any one among the permanent magnets 6 rotated together with the rotor rotating plate 5 is not coincided with the ferrite core 3. Accordingly, the intensity of the magnetic force (i.e. counter-electromotive force) of interfering with the rotation of the rotor rotating plate 5 and generated from the permanent magnets is weak, thereby smoothly rotating the rotor rotating plate 5 having the plurality of permanent magnets 6.

In the present invention, without forming the plurality of ferrite core fixing holes 12 at regular intervals along only the circle with the predetermined diameter (for example, a large diameter in FIG. 1 and FIG. 2) in the pair of fixing plates 1, in order to increase the amount of power generation in one generator having the same volume, the plurality of ferrite core fixing holes 12 can be further formed at regular intervals along the plurality of circles having different smaller diameters in addition to the large diameter in multiple stages as shown in FIG. 4. At this time, the ferrite cores 3 having the winding coils 4 wound around the outer circumference thereof can be further formed at each pair of the ferrite core fixing holes 12 in a position facing each other.

Furthermore, as shown in FIGS. 5 (a) and (b), the plurality of permanent magnets 6, which is formed at regular intervals along the plurality of circles with different diameters, can be further formed at even inside of the rotor rotating plate 5 in multiple stages in response to the installation locations of each ferrite core 3 fixed to the ferrite core fixing holes 12, which are formed at regular intervals along the plurality of circles with different diameters in multiple stages.

At this time, in the pair of fixing plates 1, it is preferred that the plurality of ferrite core fixing holes 12 formed at regular intervals along the plurality of circles with different diameters in multiple stages and the ferrite cores 3 fixed thereto are radially formed and installed at a predetermined angle and installed around the center point of the fixing plate in consideration of the installation position of the permanent magnets 6 fixed and formed on the inner side of the rotor rotating plate 5.

Preferably, the permanent magnets 6 are rotated in accordance with the rotation of the rotor rotating plate 5 in view of the shape of the rotor rotating plate 5 having any one shape of the “I” shape, the “Y” shape, and the “+” shape and the arrangement form of the ferrite cores 3 formed between the fixing plates 1 and the permanent magnets 6, which are formed at the rotor rotating plate 5 in one stage or multiple stages, are arranged in the form of the “I” shape, the “Y” shape, the “+” shape as it is viewed from the center point of the rotor rotating plate 5 so as to allow the permanent magnets 6 to be close to one or more pairs of the ferrite cores 3 at a time when they are close to both ends of the ferrite cores 3.

On the other hand, both ends of the winding coils 4 wound on each ferrite core 3 and outputting the independently induced electromotive force or the independently induced current thereto during the operation of the generator according to the present invention should be connected to the power control unit 8 of any form installed separately with the generator

Accordingly, in the present invention, the terminal plate 7 having the plurality of terminals is formed at one fixing plate 1 or both fixing plates 1, so that both ends of the winding coils 4 wound on each ferrite core 3 and the input terminals of the power control unit 8 connected to each winding coils 4 can be integrally fixed or attachably and detachably coupled thereto, whereby having the electrical safety and rendering the beauty in the appearance of the generator itself.

Thus, in the time difference-based generator using the balance of both poles according to the present invention, the plurality of ferrite cores 3 are circularly formed between the pair of fixing plates 1 having any shape, in that the pair of rotor rotating plates 5 having the plurality of permanent magnets 6 at the outside thereof are rotated, so that the balance of both poles is established and it acts as an independent generator capable of independently generating the induced electromotive forces or the induced currents with the different time differences in the winding coils 4 wound on each ferrite core 3, thereby minimizing the heat generated from the ferrite core and the winding coils.

Accordingly, the generator can greatly improve the generation efficiency thereof and greatly increase the generation capacity, and thus greatly improve the marketability and reliability

While the present invention has been described with respect to the specific embodiments, it will be apparent to those skilled in the art that various changes and modifications may be made without departing from the spirit and scope of the present invention as defined in the following claims.

1. A time difference-based generator using a balance of both poles comprising:
a pair of fixing plates integrally coupled to each other through a fixing and space maintaining means so as to maintain a parallel state in a vertical direction, each having a rotating-shaft through-hole formed in the center thereof and a plurality of ferrite core fixing holes formed at regular intervals along a circle with a predetermined diameter;
a plurality of ferrite cores of a rod shape fixedly provided between the pair of fixing plates in such a manner that both ends of the ferrite cores are inserted into the ferrite core fixing holes, the ferrite cores allowing a magnetic field generated from permanent magnets when each permanent magnet passes by both ends of the ferrite cores exposed to outside of the fixing plates to make a closed circuit;
a plurality of winding coils provided in such a manner to be wound around an outer circumference of the ferrite cores by a predetermined number of rotation and inducing an induced electromotive force or an induced current generated when the magnetic field of the permanent magnets passes through each ferrite core so as to transmit the induced electromotive force or the induced current to a power control unit;
a pair of rotor rotating plates arranged adjacent to an outer surface of the pair of fixing plates and fixed to both ends of a rotating-shaft 51 provided in such a manner to pass through the rotating-shaft through-holes formed in the center of the fixing plates so as to rotate with the rotating-shaft in response to the number of rotation of the rotating-shaft connected to a shaft of a rotation force generating means; and
the plurality of the permanent magnets fixedly provided at predetermined intervals and positions in such a manner that S poles and N poles inside the rotor rotating plates face each other so as to be opposite to each other for providing the magnetic field to the plurality of ferrite cores,
wherein the permanent magnets are rotated in accordance with the rotation of the rotor rotating plate and the permanent magnets are arranged in the form of an “I” shape, an “Y” shape, or a “+” shape as it is viewed from a center point of the rotor rotating plate so as to allow the permanent magnets to be close to one or more pairs of the ferrite cores at a time when they are close to both ends of the ferrite cores.

2. The time difference-based generator using the balance of both poles equipment as claimed in claim 1, wherein the ferrite cores are formed with an odd number or an even number and the permanent magnet are formed with an even number or an odd number in opposition to the ferrite cores.

3. The time difference-based generator using the balance of both poles equipment as claimed in claim 1, wherein in the pair of fixing plates, a plurality of ferrite core fixing holes are further formed at regular intervals along a plurality of circles with different diameters in multiple stages and ferrite cores having winding coils wound around an outer circumference thereof are formed at each pair of the ferrite core fixing holes; and a plurality of permanent magnets, which is formed at regular intervals along a plurality of circles with different diameters, is further formed at an inside of the rotor rotating plate in multiple stages in response to installation locations of each ferrite core fixed to the ferrite core fixing holes, which are formed at regular intervals along the plurality of circles with different diameters in multiple stages.

4. The time difference-based generator using the balance of both poles equipment as claimed in claim 3, wherein, in the pair of the fixing plates, the plurality of ferrite core fixing holes formed at regular intervals along the plurality of circles with different diameters in multiple stages and the ferrite cores fixed thereto are radially formed and installed at a predetermined angle from a center point of the fixing plate.

5. The time difference-based generator using the balance of both poles equipment as claimed in claim 1, wherein the rotor rotating plate is any one of a circular shape, an “I” shape, an “Y” shape, and a “+” shape.

6. (canceled)

7. The time difference-based generator using the balance of both poles equipment as claimed in claim 1, wherein a terminal plate having a plurality of terminals is further formed at one fixing plate or both fixing plates so as to fix both ends of the winding coils wound on each ferrite core and input terminals of the power control unit connected to each winding coils thereto.

8. The time difference-based generator using the balance of both poles equipment as claimed in claim 1, wherein the fixing and space maintaining means comprises:
a plurality of supporters formed in the form of a circular rod having predetermined diameter and length and installed between the pair of fixing plates; and
a plurality of bolts and nuts for mutually fixing the pair of fixing plates to the supporter in a state that the supporters passes through the pair of fixing plates, respectively.
